(19) United States
(12) Patent Application Publication
(10) Pub. No.: US 2016/0212359 A1
(43) Pub. Date: Jul. 21, 2016

(54) SWIR CLIP ON SYSTEM

(71) Applicant: SENSORS UNLIMITED, INC., Princeton, NJ (US)

(72) Inventors: Marc Hansen, Princeton, NY (US); Jason Bylsma, Princeton, NY (US); John Tagle, Princeton, NJ (US); Michael Liland, JR., Princeton, NJ (US)

(21) Appl. No.: 13/908,495

(22) Filed: Jun. 3, 2013

(51) Int. Cl. H04N 5/33; H04N 5/232; H01L 31/0304; H04N 5/225

(52) U.S. Cl. CPC H04N 5/33; H04N 5/2252; H04N 5/23293; H01L 31/03046

(57) ABSTRACT

Provided is an electromagnetic radiation wavelength conversion module for a SLR camera body. The module can include a housing with a first end that can be releasably coupled to the SLR camera body and a second end that can be releasably coupled to a SLR lens. The module can also include an IR sensor disposed in the housing for converting an infrared radiation signature of an object into at least one digital signal and a display disposed within the module for rendering the at least one digital signal into a visible representation of the of the object that can be detected by a sensor of the SLR camera.

### FIELD OF THE INVENTION

This invention relates generally to the field of imaging, particularly infrared imaging, and specifically to the field of short wavelength infrared (SWIR) imaging.

### BACKGROUND OF THE INVENTION

Light in the SWIR band is not visible to the human eye. The visible spectrum extends from wavelengths of 0.4 microns (blue, nearly ultraviolet to the eye) to 0.7 microns (deep red). Wavelengths longer than visible wavelengths can only be seen by dedicated sensors, such as InGaAs-based sensors. However, SWIR light is reflective light which bounces off of objects much like visible light. As a result of its reflective nature, detected SWIR light can have shadows and contrast in its imagery. For low light level imaging applications, noise/leakage current such as dark current must be reduced to obtain sufficient sensitivity.

Sensors constructed from materials like mercury cadmium telluride (HgCdTe) or indium antimonide (InSb) can be very sensitive in the SWIR band. However, at least in the case of HgCdTe, because of high dark current, these devices must be mechanically cooled, often to extremely low temperatures, which increases power consumption, size and cost of cameras that utilize such sensors.

Thermal imagers are another class of camera with good detection abilities. While thermal imaging can detect the presence of a warm object against a cool background, they provide low resolution and dynamic range.

CMOS and CCD imagers are excellent devices that continue to evolve to meet military needs. But such sensors are typically just daylight sensors.

InGaAs sensors can be made extremely sensitive, literally counting individual photons. Thus, when built as focal plane arrays with thousands or millions of tiny point sensors, or sensor pixels, SWIR cameras will work in very dark conditions. Although InGaAs sensors have not reached the megapixel resolution of visible (silicon) sensors, images from an InGaAs-sensor based camera can provide useful details; however, SWIR images are not in color. This makes objects easily recognizable and yields one of the tactical advantages of the SWIR, namely, object or individual identification.

Conventional cameras include sensors that are able to image only in the visible spectrum. For example, an SLR (single-lens reflex) camera is typically operated during the day, or at night with the use of a bright flash at close distances in order to capture images. However, in low light conditions or in situations where direct view of objects is blocked by environmental conditions such as haze, fog, smoke or dust, conventional cameras by themselves are unreliable. Alternative dedicated imagers such as night vision systems or SWIR dedicated cameras have been developed. However, it is not practical for an operator in the field to carry several different types of cameras due to size and weight limitations. Accordingly, modules have been developed to convert cameras, such as SLR cameras, into night vision systems. For example, the ASTROSCOPE™ Night Vision system for Canon EOS dSLR Cameras (available from Electrophysics Corp., Fairfield, N.J.). However, such a system relies on a central intensifier unit that amplifies light received through an objective lens.

### SUMMARY

In an embodiment, there is an electromagnetic radiation wavelength conversion module for a SLR camera body. The module can include a housing with a first end that can be releasably coupled to the SLR camera body and a second end that can be releasably coupled to a SLR lens. The module can also include an IR sensor disposed in the housing for converting an infrared radiation signature of an object into at least one digital signal and a display disposed within the module for rendering the at least one digital signal into a visible representation of the object that can be detected by a sensor of the SLR camera.

In another embodiment there is an electromagnetic radiation conversion system that includes an SLR camera comprising an SLR camera sensor, an SLR camera zoom lens, and an electromagnetic radiation wavelength conversion module releasably coupled between the SLR camera and the SLR camera zoom lens. The electromagnetic radiation wavelength conversion module can include a housing, an infrared sensor disposed within the housing for converting an infrared radiation signature of an object into at least one digital signal, a display disposed within the housing for rendering the at least one digital signal into a visible representation of the object that can be detected by the SLR camera's visible light sensor, and an optical relay for directing the visible representation from the display to the SLR camera sensor.

In yet another embodiment, there is a method of providing an image to a camera. The method can include directing an infrared radiation signature of an object collected by an SLR lens to an electromagnetic radiation wavelength conversion module which is releasably coupled to the SLR lens and to an SLR camera, converting the infrared radiation signature into at least one digital signal with an IR sensor that is disposed in the module, displaying a visible representation of the object rendered from the at least one digital signal with a display that is disposed in the module, directing the visible representation to the SLR camera, converting the visible representation into an other at least one digital signal with a SLR camera sensor disposed in the SLR camera body, an displaying a viewable representation of the visible representation rendered from the other at least one digital signal with an SLR camera display.

Advantages of at least one embodiment include minimized-to-no degradation of performance due to bright lights and flashes. An advantage of at least one embodiment includes the ability to image through glass, which is an advantage over thermal cameras. An advantage of an embodiment includes imaging through conditions that hinder conventional imagers including haze, fog, smoke or dust. An advantage of an embodiment includes the ability to attach an electromagnetic radiation wavelength conversion module to existing commercial cameras and lenses thereby providing increased low-light performance over visible cameras.

Additional advantages of the embodiments will be set forth in part in the description which follows, and in part will be understood from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 includes a perspective view of an electromagnetic radiation conversion module.

FIG. 2 includes another perspective view of the electromagnetic radiation conversion module of FIG. 1.

FIG. 3A includes a side view of the electromagnetic radiation conversion module of FIG. 1.

FIG. 3B is a side view of the electromagnetic radiation conversion module of FIG. 3a.

FIG. 4 a perspective view of an electromagnetic radiation conversion system that includes an SLR camera, an SLR camera zoom lens and an electromagnetic radiation wavelength conversion module releasably coupled therebetween.

FIG. 5 is a cross-sectional view of an electromagnetic radiation conversion system, for example, that of FIG. 4.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

The following embodiments are described for illustrative purposes only with reference to the Figures. Those of skill in the art will appreciate that the following description is exemplary in nature, and that various modifications to the parameters set forth herein could be made without departing from the scope of the present invention. It is intended that the specification and examples be considered as examples only. The various embodiments are not necessarily mutually exclusive, as some embodiments can be combined with one or more other embodiments to form new embodiments.

Embodiments described herein include an electromagnetic radiation wavelength conversion module that can effectively convert a standard commercial camera, such as an SLR camera, into an SWIR imager. The module can be attached to the front of such a camera. Upon attaching the module, the converted camera can provide operators with capabilities to view SWIR wavelengths that are converted to visible wavelengths via the module. Thus, because otherwise nonvisible SWIR wavelengths are made visible via the integrated displays of the module embodiments, operators are given the ability to view objects through haze, fog, smoke and dust, to view battlefield lasers and view SWIR markers/beacons, thereby allowing for enhanced long range intelligence, surveillance and reconnaissance.

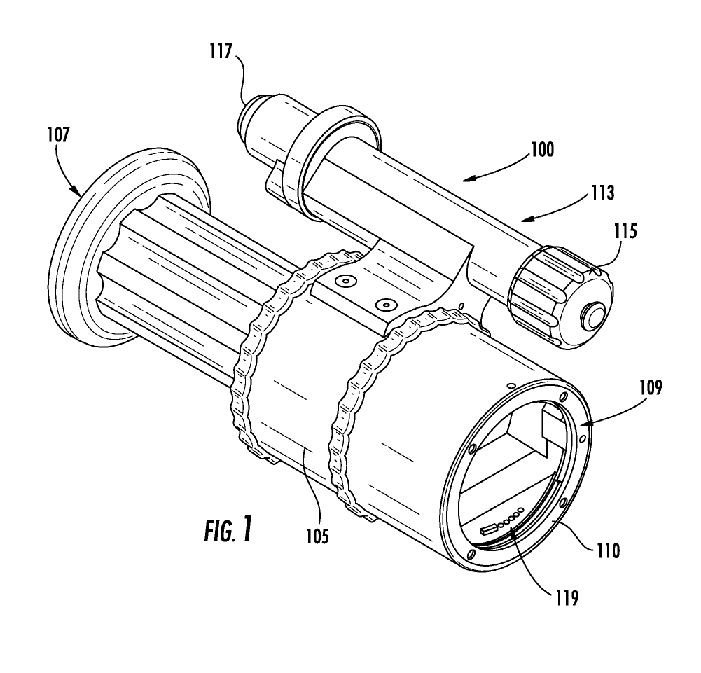

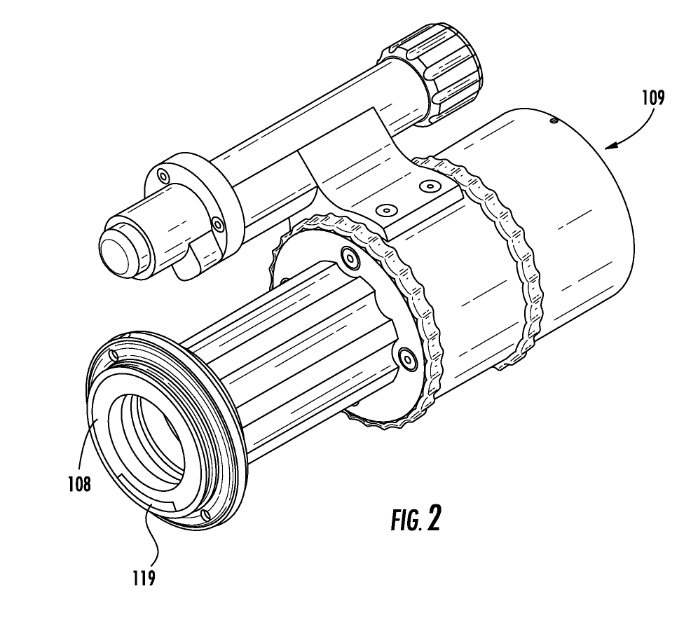

Accordingly, FIGS. 1-3B show a electromagnetic radiation wavelength conversion module 100. In an embodiment, the module 100 can include a housing 105, sensor 111, and display 101. Sensor 111 and display 101 can be disposed within the housing. Sensor 111 can be an IR sensor, for converting an infrared radiation signature of an object into at least one digital signal, a display 101 for rendering the at least one digital signal into a visible representation of the of the object that can be detected by a sensor of the SLR camera. Housing 105 can have a first end 107 that can be releasably coupled to a camera body, such as an SLR camera body, and a second end 109 that can be releasably coupled to a lens housing, such as to an SLR zoom lens. For example, the first end 107 can include a mount such as flanges with features configured to either receive and/or be received by corresponding features on the camera. In an example, first end 107 can be a CANON™ male bayonet adapter compatible with a CANON™ EOS camera body. Similarly, the second end 109 can include a mount 110 such as flanges with features configured to either receive and/or be received by corresponding features on a zoom lens. In an example, second end 109 can be a CANON™ female bayonete adapter compatible with CANON™ EF and EF-S lenses. In an embodiment, module 100 can be clipped on to a camera, such as to the front of a conventional camera where a zoom lens would otherwise be clipped-on/fastened/attached. In an embodiment, a lens, such as a conventional zoom lens that can be directly attached to a conventional camera, can be clipped to an end of the module, such as at end 109. In an embodiment, display 101 can be located between the first end 107 and the sensor 111, and the sensor 111 can be located between the display 101 and the second end 109.

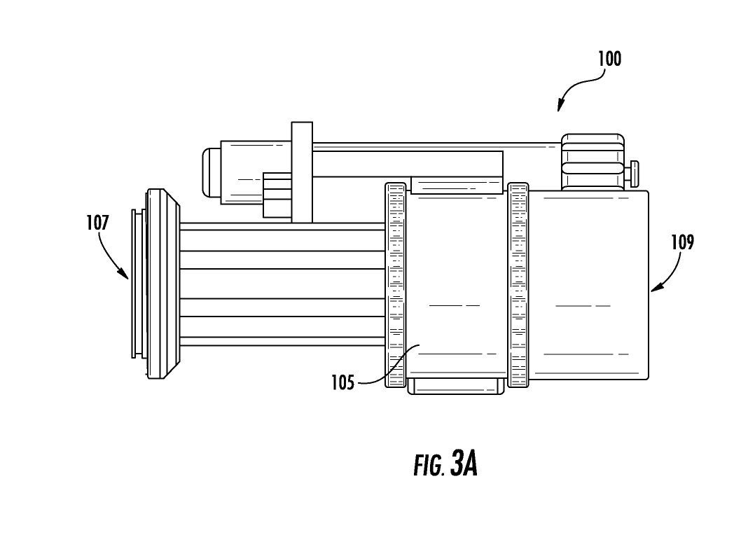

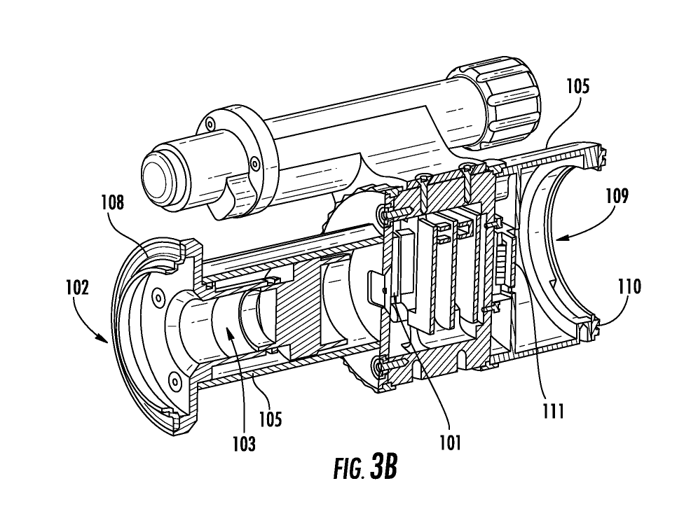

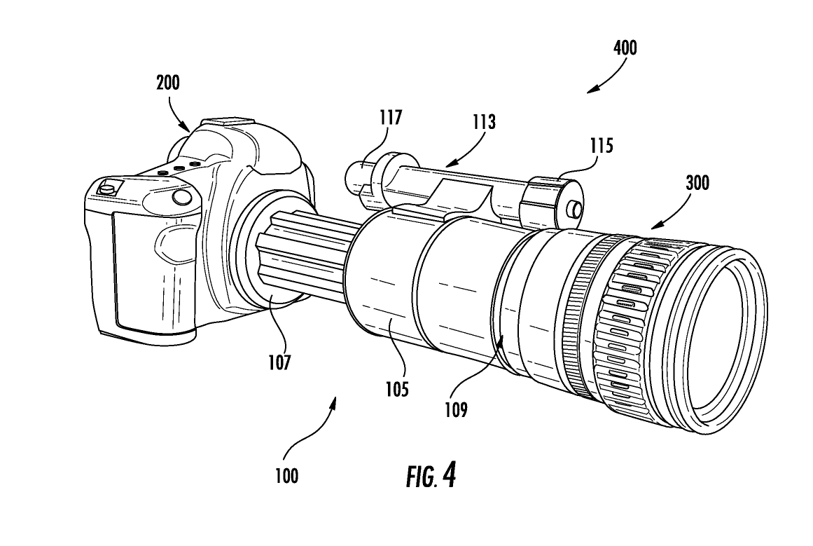

Although features of the electromagnetic radiation wavelength conversion module can be configured linearly as shown, for example as shown in FIG. 3B and FIG. 4, other embodiments can provide features arranged in a non-linear configuration. For example, with first end 107 optically aligned with sensor 111, and display 101 optically aligned with end 109, an embodiment of an electromagnetic radiation wavelength conversion module can be configured to operate at right angles in order to provide around-corner viewing between a zoom lens and a camera. In another embodiment, the module can be configured to operate remotely, physically separated from the camera and/or zoom lens.

The electromagnetic radiation wavelength conversion module 100 can further include a power source 113 which can be attached to the housing 105 and can be in electrical communication with components of the module, such as with the sensor 111 and display 101. The power source 113 can itself be a battery or can include removable and/or replaceable batteries. Accordingly, the power source 113 can be configured as compartment in which batteries can be disposed. In other words power source 113 can hold batteries and can include a removeable battery compartment cap 115 that allows access to an inside cavity where the batters are held. In an embodiment, the power source 113 can be an interchangeable power source, such as a clip-on stick that holds rechargeable batteries, or is itself configured with electrodes for placing on a recharger, that can be completely swapped out for a similarly configured interchangeable and/or rechargeable power source. The power source 113 can also be electrically connected to a power switch 117, such as an environmentally sealed power switch designed for gloved hand operation. In an embodiment, the power source 113 is configured with an auto power shut down feature to conserve battery life. In an embodiment, the power source 113 can include a battery life indicator such as at least one LED disposed on the module for indicating a battery life, such as available battery life, full battery life and/or low batter life.

The electromagnetic radiation conversion module 100 can also include an electronic relay 119 configured to provide electronic communication between a controller of a camera and an optical control system of the lens housing. In other words, the electronic relay 119 can include electronic contacts for communicating zoom, image stabilization, and autofocus (AF) information between the camera and the zoom lens. Thus, the electronic relay 119 can function as a lens contact feed-thru disposed in housing 105.

The sensor 111 of the electromagnetic radiation wavelength conversion module 100 can be an IR sensor, such as a NIR sensor and/or a SWIR sensor. In an example, the sensor 111 can be an InGaAs based sensor. Such a SWIR sensor can be, for example, the sensor used in an SUI 640HSX SWIR camera core (available from Sensors Unlimited, Inc., Princeton, N.J.).

The electromagnetic radiation conversion module 100 can further include an optical relay 103 for magnifying the visible image. For example, an optical relay 103 can be utilized in the module 100 for proper magnification of the visible image over a fixed distance between display 101 and the sensor of a camera to which module 100 is attached. In an embodiment, optical relay 103 can include one or more of a glass element configured to magnify the visible display provided by the module display 101 and scaled to the camera sensor size, such as over a fixed distance.

The module's display 101 can be an integrated 800×600 SVGA display. For example, the module's display 101 can be an LCD display or an OLED display, for example, any commercially available microdisplay.

The module 100 can be releasably attached to a camera body and to a zoom lens to form an electromagnetic radiation conversion system 400, such as that shown in FIG. 4. In an embodiment, an electromagnetic radiation conversion system 400 can include a camera 200, such as an SLR camera, and a lens, such as a zoom lens 300, and an electromagnetic radiation wavelength conversion module 100, releasably coupled to and between the camera 200 and lens 300.

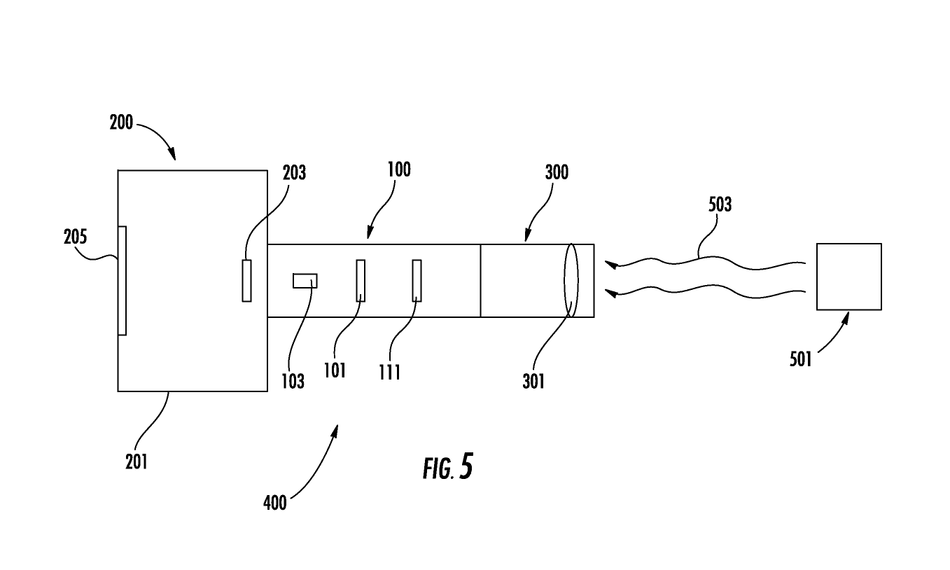

As shown in FIG. 5, the camera can include a body 201. Electromagnetic radiation wavelength conversion module 100 can be releasably coupled, via end 107, for example, to the camera housing 201 and to lens 300 via end 109. Accordingly, module 100 can extend between the camera 200 and lens 300.

Camera 200 can include a sensor 203, such as an SLR camera sensor, that can convert visible light into at least one electronic signal, such as a digital signal. The sensor 203 can be disposed in the camera housing 201. Camera 200 can also include a display 205, such as an SLR camera display, which can be in electronic communication with sensor 203.

Zoom lens 300 can include at least one lens 301 such as at least one concave and/or at least one convex lens. An electromagnetic radiation signature 503, such as an infrared radiation signature, of an object 501 can be directed to a zoom lens 300 and therein refracted, reflected, and/or fully or partially transmitted through the at least one lens 301. The electromagnetic radiation signature 503 can thus be directed through lens housing 300 to the module 100, for example, to sensor 111. Alternatively, if lens housing 300 and module 100 are not attached to one another, the electromagnetic radiation signature 503 can be directed to module 100 without the need for it to pass through zoom lens 300.

In an example, an object's electromagnetic radiation signature 503 can include radiation created by the object and emitted therefrom, or radiation which is reflected from the object, for example, as reflected infrared light from a surface of the object. The object's electromagnetic radiation signature 503 can include, for example, visible electromagnetic radiation such as light having a wavelength of about 380 nm to about 700 nm and non-visible infrared electromagnetic radiation such as light having a wavelength of about greater than 700 nm to about 1 mm. In particular, a non-visible electromagnetic radiation signature can include near-infrared (NIR) light, NIR-SWIR light, and SWIR light, such as that in the range of about 0.70 μm to about 1.7 μm, about 0.75 μm to about 1.4 μm, about 0.9 μm to about 1.7 μm, and/or that in the range of greater than about 1.4 μm to about 3 μm.

Accordingly, an infrared radiation signature can be directed by zoom lens 300, such as via refraction or magnification by the at least one lens 301, to module 100. At module 100, the infrared radiation can be detected by sensor 111. Sensor 111 can convert the infrared radiation into an electronic signal. The electronic signal can be a a signal, such as a digital signal that a display 101 is configured to receive, or can be converted to such a signal between the sensor 111 and the display 101. For example, the electronic signal can be converted into a digital signal which can be used for forming an image on display 101. In other words, a digital signal that is representative of incoming infrared radiation can be converted into a visible representation of the object's infrared radiation signature.

In an example, an infrared radiation signature 503 of object 501 can be sensed by sensor 111 and converted into at least one digital signal, the at least one digital signal being representative of the radiation signature of the object, which in turn can be interpreted by and displayed as a visible representation (i.e., visible electromagnetic radiation) on display 101. The visible representation of the infrared radiation on display 101 can then be directed to the SLR camera, such as to camera's sensor 203.

In an example, the visible representation from display 101 can be manipulated by an optical relay 103, such as to provide a magnified and/or focused image to the camera. Accordingly, the visible representation of the object's infrared signature can be detected by the camera's sensor 203 and converted to at least one electronic signal, such as a digital signal. This at least one electronic signal can be can be interpreted by and displayed as a viewable representation (i.e., visible electromagnetic radiation that can be viewed by an operator of the camera) on display 205. Because the visible representation from display 101 can be manipulated by an optical relay 103, full viewfinder imagery can be displayed on display 205 without the need for utilizing the camera's on-board digital zoom function.

The at least one electronic signal generated by sensor 203 can be translated by an electronics system of the camera and displayed as a still-image viewable representation or as a real-time or near-real-time refreshing-image viewable representation on display 205 of visible representation displayed on display 101. The at least one electronic signal generated by sensor 203 can also be stored as a picture or movie according to features and methods known in the art.

Accordingly, the otherwise non-visible features of object 501 can thus be viewed by an operator as a viewable representation shown on display 205, stored or captured as an image file or movie file on machine readable media as a picture or movie, for example. The non-visible features of object 501 could be those features that would otherwise be masked by intervening environmental conditions, such as a lack of sufficient light the presence of haze or fog. Such masked features would otherwise not be detectable by camera 200's sensor 203 nor viewable on display 205 without the conversion of the object's infrared signature by sensor 111 into at least one electronic signal that can be interpreted and displayed on display 101 as a visible representation in the module 100, and the further conversion of the visible representation directed from the module to the sensor 203 into at least one electronic signal that can be interreted and displayed on display 205 to the camera's operator as a viewable representation.

In other words, when module 100 is releasably coupled to the camera housing 201 and lens 300, a viewable imagine on the module's display 101 is directed to sensor 203 of the camera 200, converted into electronic signals that can be interpreted by display 205, and displayed as a viewable representation of the object's infrared signature.

Additionally, in a conventional camera system, the zoom lens may be directly attached to the camera body. On board electronics located in the camera body, such as the camera's controller, can activate motors in the zoom lens to adjust an automatic focus feature and zoom capabilities. Accordingly, electromagnetic radiation conversion systems 400 can likewise provide similar electrical communication/control between camera 200 and lens 300 when module 100 is attached thereto. For example module 100 with its electronic feed thru 119 can provide electronic communication between the camera body and the zoom lens when mounted in between the camera and the zoom lens. Thus, a zoom setting of zoom lens 300 can be adjusted with electrical signals from a controller (not shown) of the camera 200, wherein electrical signals are communicated through electrical relay 119 that is in electrical communication with the controller and electronic components of the lens.

While the invention has been illustrated respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function.

Furthermore, to the extent that the terms “including”, “includes”, “having”, “has”, “with”, or variants thereof are used in either the detailed description and the claims, such terms are intended to be inclusive in a manner similar to the term “comprising.” As used herein, the phrase “one or more of”, for example, A, B, and C means any of the following: either A, B, or C alone; or combinations of two, such as A and B, B and C, and A and C; or combinations of three A, B and C.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An electromagnetic radiation wavelength conversion module for a SLR (Single-Lens Reflex) camera body, comprising:
a housing with a first end that can be releasably coupled to the SLR camera body and a second end that can be releasably coupled to a SLR lens;
an IR sensor disposed in the housing for converting an infrared radiation signature of an object into at least one electronic signal; and
a display disposed within the housing for converting the at least one electronic signal into a visible representation of the object at the display that can be detected by a sensor of the SLR camera.

2. The electromagnetic radiation wavelength conversion module of claim 1, further comprising an optical relay for magnifying the visible representation.

3. The electromagnetic radiation wavelength conversion module of claim 1, further comprising a power source electrically connected to at least the IR sensor.

4. The electromagnetic radiation wavelength conversion module of claim 1, wherein the display is an LCD display or an OLED display.

5. The module of claim 1, wherein the display is located between the first end and the IR sensor, and the IR sensor is located between the display and the second end.

6. The electromagnetic radiation wavelength conversion module of claim 1, wherein the IR sensor comprises an InGaAs sensor.

7. The electromagnetic radiation wavelength conversion module of claim 1, further comprising an electronic relay configured to provide electronic communication between a controller of the SLR camera and an optical control system of the SLR lens.

8. The electromagnetic radiation wavelength conversion module of claim 7, wherein the electronic relay is further configured to provide electronic communication between the SLR camera controller and the display disposed within the module.

9. An electromagnetic radiation conversion system, comprising:
a Single-Lens Reflex (SLR) camera comprising an SLR camera sensor;
a SLR camera zoom lens;
an electromagnetic radiation wavelength conversion module releasably coupled between the SLR camera and the SLR camera zoom lens, the module comprising:
a housing,
an infrared sensor disposed within the housing and for converting an infrared radiation signature of an object into at least one electronic signal,
a display disposed within the housing for converting the at least one electronic signal into a visible representation at the display of the object that can be detected by the SLR camera's visible light sensor, and
an optical relay for directing the visible representation from the display to the SLR camera sensor.

10. The electromagnetic radiation conversion system of claim 9, wherein the SLR camera further comprises an SLR camera display for displaying rendered digital signals generated by the SLR camera sensor into a viewable representation of the visible representation.

11. The electromagnetic radiation conversion system of claim 9, wherein the module's display is an LCD display or an OLED display.

12. The electromagnetic radiation conversion system of claim 9, wherein the IR sensor is configured to detect SWIR.

13. The electromagnetic radiation conversion system of claim 9, further comprising an electronic relay configured to provide electronic communication between a controller of the SLR camera and an optical control system of the SLR lens.

14. The electromagnetic radiation conversion system of claim 13, wherein the electronic relay is further configured to provide electronic communication between the controller and the module's display.

15. The electromagnetic radiation conversion system of claim 9, wherein the module further comprises a power source electrically connected to at least the IR sensor.

16. A method of providing an image to a camera, the method comprising,
directing an infrared radiation signature of an object collected by an SLR zoom lens to an electromagnetic radiation wavelength conversion module which is releasably coupled to the SLR zoom lens and to an SLR camera;
converting the infrared radiation signature into at least one electronic signal using an IR sensor that is disposed in the module;
converting the at least one electronic signal to at least one digital signal;
rendering a visible representation of the object from the at least one digital signal at a display that is disposed in the module;
directing the visible representation from the display to the SLR camera;
converting the visible representation into another at least one digital signal with a SLR camera sensor disposed in the SLR camera body; and
displaying a viewable representation of the visible representation rendered from the other at least one digital signal with an SLR camera display.

17. The method of claim 16, further comprising manipulating the visible representation with an optical relay disposed in the module.

18. The method of claim 17, wherein manipulating the visible representation comprises magnifying.

19. The method of claim 16, wherein the infrared radiation is SWIR radiation.

20. The method of claim 16, further comprising adjusting a zoom setting of the SLR zoom lens with electrical signals from a controller of the SLR camera, wherein electrical signals are communicated through a electrical relay that is in electrical communication with the controller and the SLR zoom lens.

21. The electromagnetic radiation wavelength conversion module of claim 1, wherein the electronic signal is converted to a digital signal that is used to render the visible representation at the display.
